(19) United States
(12) Patent Application Publication
(10) Pub. No.: US 2013/0180788 A1
(43) Pub. Date: Jul. 18, 2013

(54) Electric Car

(71) Applicants: Bruce Jin, Temple City, CA (US); Shida Zhang, Temple City, CA (US)

(72) Inventors: Bruce Jin, Temple City, CA (US); Shida Zhang, Temple City, CA (US)

(21) Appl. No.: 13/352,747

(22) Filed: Jan. 18, 2012

(51) Int. Cl. B60K 1/00; B60N 2/01; B60N 2/005; B60K 1/04; B62D 31/00

(52) U.S. Cl. 180/65.1

(57) ABSTRACT

An electric car defined by means of a car body having a front end, a rear end, a top portion and a bottom portion. A center console is placed at an interior forepart of the electric car. A steering is attached to the center console. A rectangular seat is mounted on a rectangular box, the rectangular box being longitudinally placed at a center part of the electric car. A storage area having a personal storage and a battery storage is enclosed within the rectangular box. The battery storage includes a battery pack having a set of rechargeable batteries for powering the electric car. A plug point is located at a rear end of the electric car for charging the battery pack. A pair of rotatable front wheels and back wheels is provided for ensuring smooth movement of the electric car. The electric car is designed to achieve better performance by reducing the power consumption.

### BACKGROUND OF THE DISCLOSURE

1. Technical Field of the Disclosure

This embodiment relates in general to electric cars. More specifically, the preferred embodiment relates to an electric car having a vertical row of seats.

2. Description of the Related Art

An electric car is powered by an electric motor using electrical energy stored in batteries or other charged devices. Electric cars are environment friendly as it do not produce any harmful gases such as carbon monoxide, organic compounds, hydro carbons etc. Electric cars are economical because of very low maintenance and operating costs.

Conventional electric cars have considerable drawbacks. For example, an existing electric car includes an electric drive and at least one connected electrical energy storage module. A guide extends longitudinally along the motor vehicle, and supports the storage module in a manner relative to the motor vehicle. Conventional electric cars employ horizontal rows of seats consuming excess space.

Another existing electric vehicle is capable of carrying at least two passengers and has at least three wheels. Passengers sit in tandem and most of the batteries or fuel cell systems are located to the sides of the passengers. This vehicle has an aerodynamically shaped body with substantially reduced frontal area and drag. The body is lightweight, made from shock absorbing materials and structures, and has pressure-airless tires, which enhances the safety of the passengers. The vehicle also includes an advanced hydrogen-electric hybrid propulsion system with quick refueling from existing infrastructure and various additional optional features and systems. However the batteries or fuel cell systems are placed to the sides of the passengers which increases the overall the dimension and weight of the vehicle.

Yet another existing electrical car embodiment is comprised of bodywork with ground-engaging wheels for vehicle motion over the ground, the bodywork contains an electric motor to drive the vehicle via the wheels and batteries to power the electric motor.

This embodiment provides an additional energy generation means comprised of a tunnel extending through the bodywork. It includes a turbine fan/alternator set located in the tunnel at the rear of the vehicle where electrical energy is generated during vehicle motion to charge the batteries. This results in improved performance of the vehicle, especially with regard to its range. The inlet to the tunnel at the vehicle front constitutes the major portion of the vehicles frontal area. A special alternator is provided, and the vehicle can also include a solar cell means for battery charging. However, the seats are placed far apart which consumes a lot of space.

Hence, it can be seen, that there is a need for an electric car that contains a vertical rows of seats. This needed electric car would save more space than existing models to form a vehicle of smaller size with more passengers. Moreover, this needed electric car would consume less power and use a less bulky charging means during transportation. The present embodiment accomplishes these objectives.

### SUMMARY OF THE DISCLOSURE

To minimize the limitations found in the prior art, and to minimize other limitations that will be apparent upon the reading of the specifications, the present invention provides an electric car having a vertical row of seat for accommodating at least one passenger. The electric car comprises a center console placed at an interior forepart of the electric car. A steering is attached to the center console. A rectangular seat is mounted on a rectangular box, the rectangular box being longitudinally placed at a center part of the electric car. A storage area is enclosed within the rectangular box, the storage area includes a personal storage and a battery storage. The battery storage includes a battery pack having a set of rechargeable batteries. The battery pack is used to power the electric car. A plug point is located at a rear end of the electric car for charging the battery pack. A pair of rotatable front wheels and a pair of rotatable back wheels are provided for ensuring smooth movement of the electric car. Both the center console and the steering of the electric car are aligned with the rectangular seat. The rectangular seat is mounted on the rectangular box having the storage area in order to save space. The electric car is configured to have a compact seating arrangement. A back support may be provided for a driver's rectangular seat. The electric car is specially designed to achieve better performance by increasing the energy efficiency and reducing the power consumption. The at least one passenger can be seated facing front direction with one leg on each side of the rectangular seat. The electric car is capable of accommodating more passengers with relatively small size and with minimum power consumption during transportation.

In alternate embodiment of the present invention at least one step and ladder seat is positioned at the center part of the electric car. The electric car comprises a car body having a front end, a rear end, a top portion and a bottom portion. A center console placed at an interior forepart of the electric car. A steering is attached to the center console. At least one step and ladder seat is positioned at the center part of the electric car for accommodating at least one passenger. In addition to the at least one step and ladder seat, a horizontal row of seats for accommodating a pair of passengers is located at the rear end of the vehicle. A battery storage having a battery pack is positioned at the bottom portion of step and ladder seat for powering the electric car. A plug point is located at a rear end of the electric car for charging the battery pack. A personal storage is placed at the rear end of horizontal row of seat.

One objective of the invention is to provide an electric car capable of accommodating four or more passengers with relatively smaller vehicle size.

Another objective of the invention is to provide an electric car with compact seating arrangement.

A third objective of the invention is to provide an electric car with better performance by increasing the energy efficiency and reducing the power consumption.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 shows a side view of an electric car for accommodating at least one passenger;

FIG. 2 shows a top view of the electric car;

FIG. 3 shows the electric car in use, accommodating the at least one passenger in a rectangular seat longitudinally placed at a center part of the electric car;

FIG. 4 shows a side view of alternate embodiment of the present invention wherein at least one step and ladder seat is positioned at a center part of the electric car;

FIG. 5 shows the top view of alternate embodiment of the present invention wherein the at least one step and ladder seat is positioned at the center part of the electric car; and

FIG. 6 shows a rear perspective view of another alternate embodiment of the electric car.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

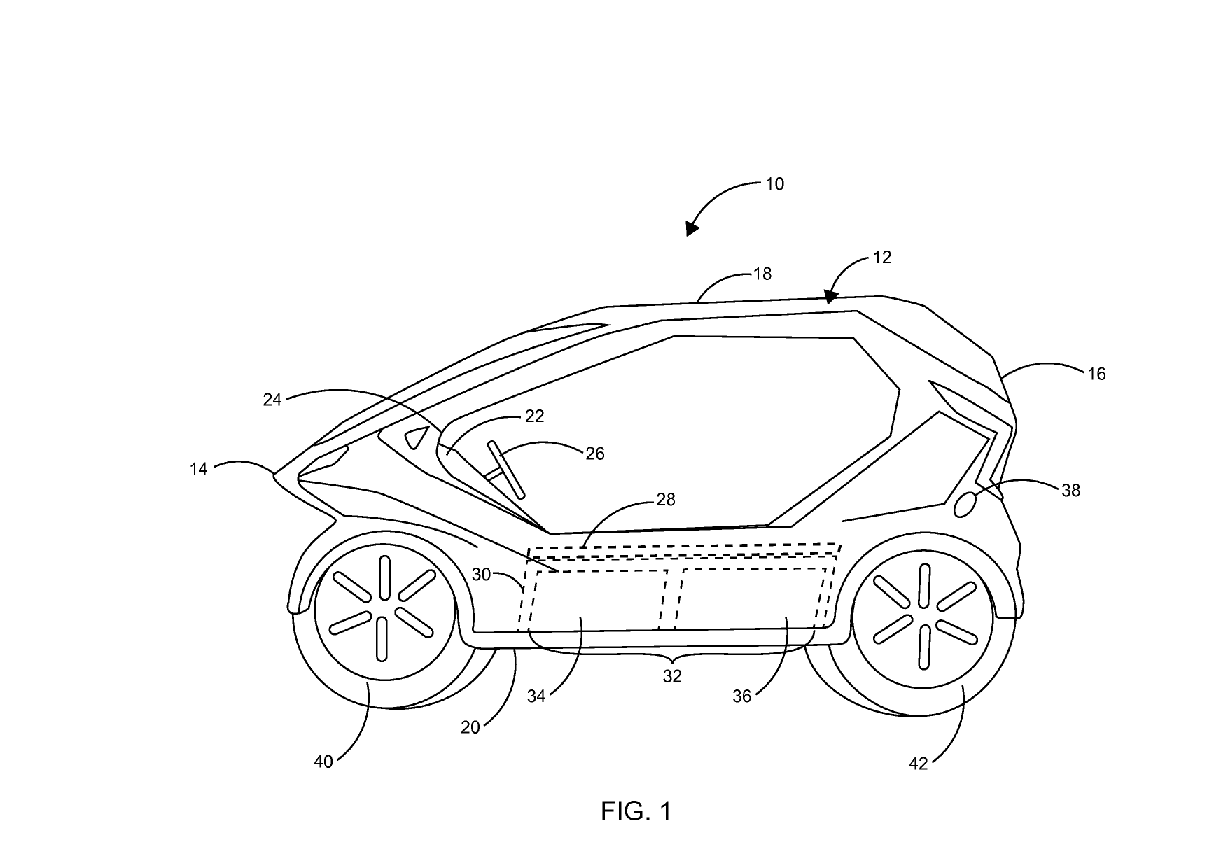

FIG. 1 shows a side view of an electric car 10 for accommodating at least one passenger. The electric car 10 comprises a car body 12 having a front end 14, a rear end 16, a top portion 18 and a bottom portion 20. A center console 22 is placed at an interior forepart 24 of the electric car 10. A steering 26 is attached to the center console 22. A rectangular seat 28 is mounted on a rectangular box 30, the rectangular box 30 is longitudinally placed at a center part of the electric car 10. A storage area 32 is enclosed within the rectangular box 30, the storage area 32 includes a personal storage 34 and a battery storage 36. The battery storage 36 includes a battery pack (not shown) having a set of rechargeable batteries (not shown). The battery pack (not shown) is used to power the electric car 10. A plug point 38 is located at a rear end 16 of the electric car 10 for charging the battery pack (not shown). A pair of rotatable front wheels 40 and a pair of rotatable back wheels 42 are provided for ensuring smooth movement of the electric car 10.

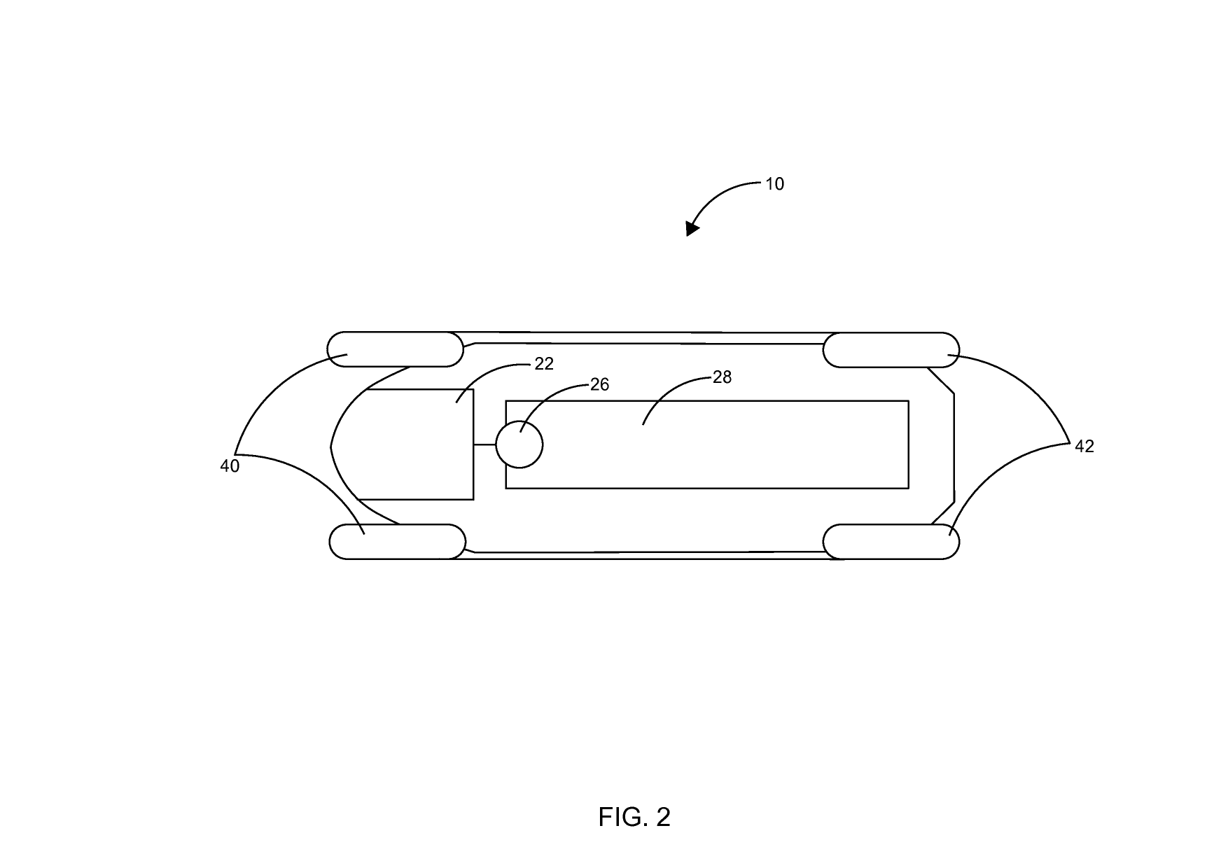

FIG. 2 shows a top view of the electric car 10. Both the center console 22 and the steering 26 of the electric car 10 are aligned with the rectangular seat 28. The rectangular seat 28 is mounted on the rectangular box 30 having the storage area 32 in order to save space. The electric car 10 is configured to have a compact seating arrangement. A back support (not shown) may be provided for a driver's rectangular seat 28. The electric car 10 is designed to achieve better performance by increasing the energy efficiency and reducing the power consumption.

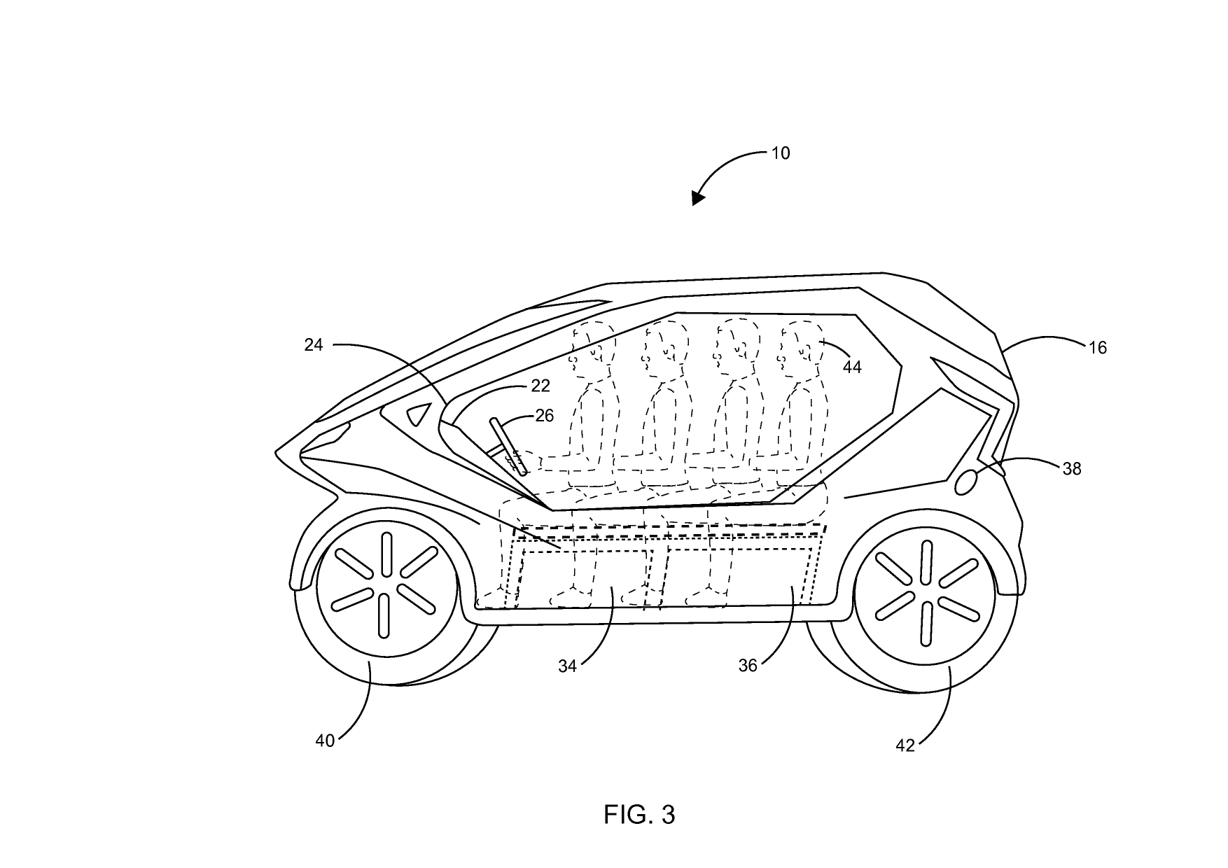

FIG. 3 shows the electric car in use, accommodating the at least one passenger in the rectangular seat longitudinally placed at a center part of the electric car 10. The at least one passenger 44 can be seated facing front direction with one leg on each side of the rectangular seat 28. The purpose of the invention is to create a low cost electric car that can load four or more passengers with relatively smaller vehicle size for less power consumption and is best suited for transportation in short commute situations.

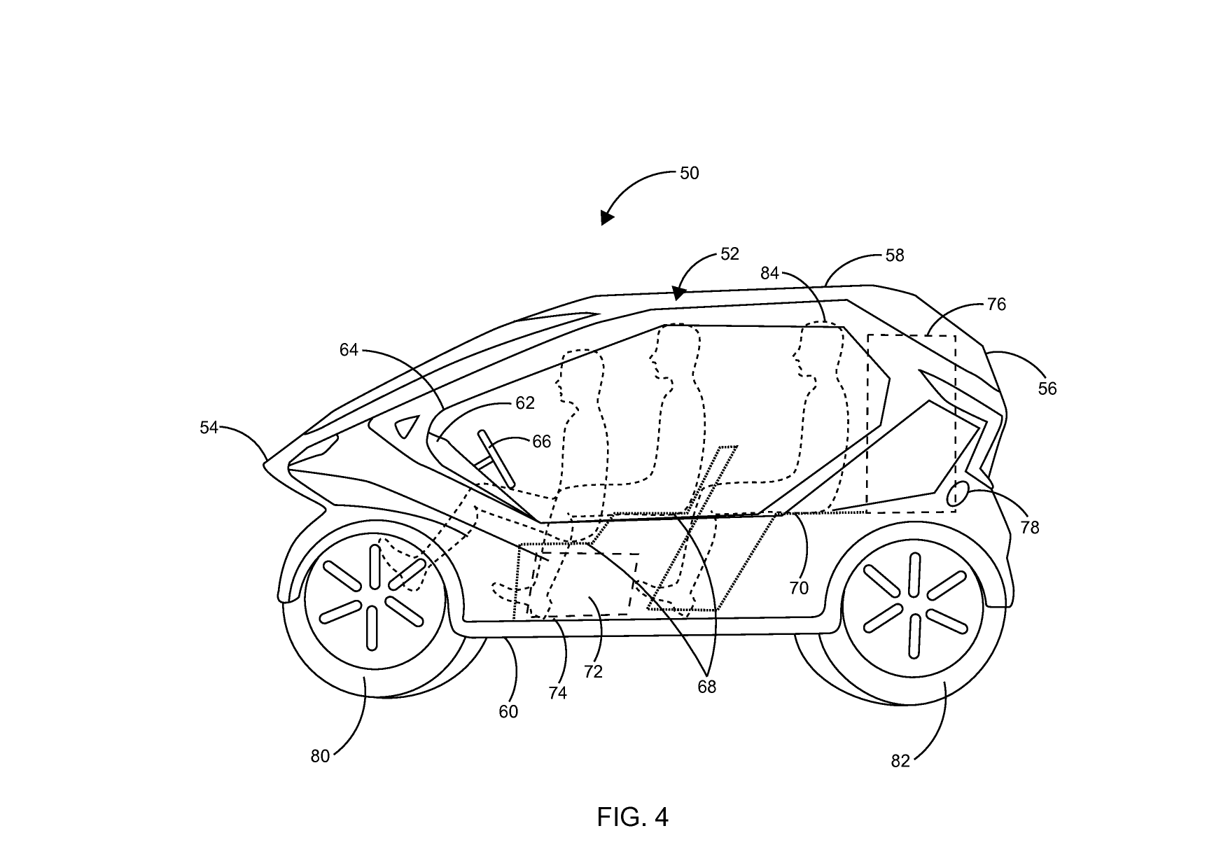

FIG. 4 shows a side view of an alternate embodiment of the present invention wherein at least one step and ladder seat 68 is positioned at the center part of the electric car 50. An electric car 50 comprises a car body 52 having a front end 54, a rear end 56, a top portion 58 and a bottom portion 60. A center console 62 placed at an interior forepart 64 of the electric car 50. A steering 66 is attached to the center console 62. At least one step and ladder seat 68 is positioned at a center part of the electric car 50 for accommodating at least one passenger 84. In addition to the at least one step and ladder seat 68, a horizontal row of seats 70 for accommodating a pair of passengers 84 is located at a rear end 56 of the electric car 50. A battery storage 72 having a battery pack (not shown) is positioned at the bottom portion 74 of step and ladder seat 68 for powering the electric car 50. A personal storage 76 is placed at the rear end 56 of the horizontal row of seats 70. A plug point 78 is located at a rear end 56 of the electric car 50 for charging the battery pack (not shown). A pair of rotatable front wheels 80 and a pair of rotatable back wheels 82 are provided for ensuring smooth movement of the electric car 50.

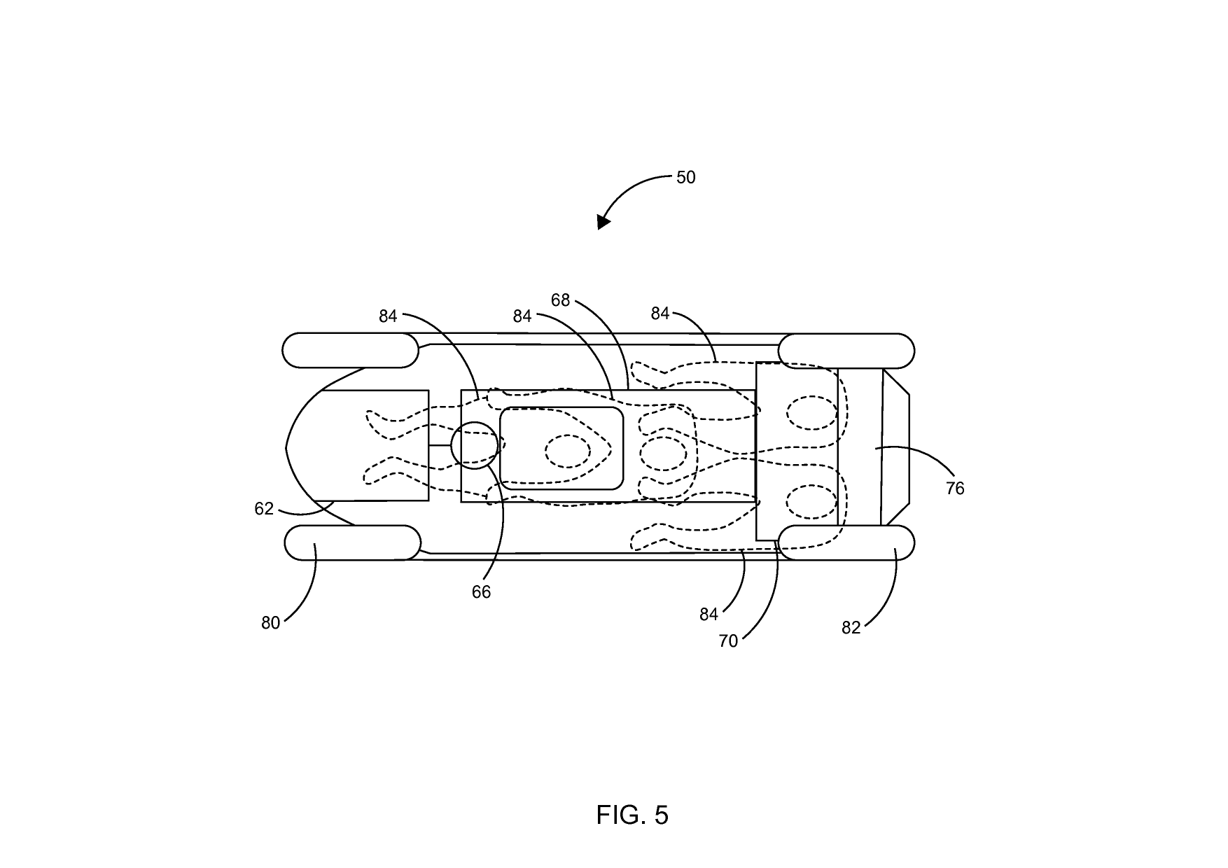

FIG. 5 shows the top view of alternate embodiment of the present invention wherein the step and ladder seat is positioned at the center part of the electric car 50. In addition to the step and ladder seat 68, a horizontal row of seats 70 for accommodating at least one passenger is located at the rear end 56 of the electric car 50. A battery storage 72 having a battery pack (not shown) is positioned at the bottom portion 74 of the step and ladder seat 68 for powering the electric car 50. A personal storage 76 is placed at the rear end 56 of the horizontal row of seats 70. In an alternate embodiment, the passengers can be seated facing the side of the car with both legs on one side of the box seats.

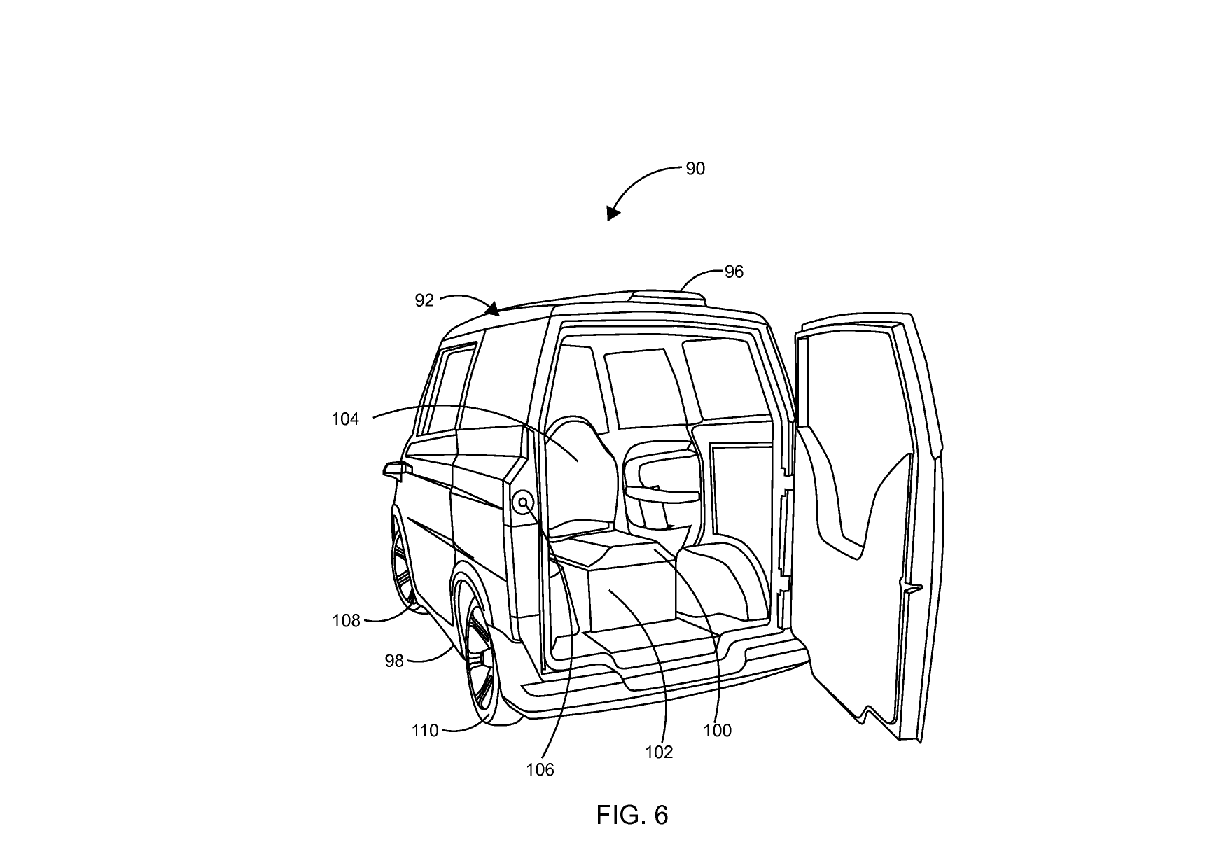

FIG. 6 shows a rear perspective view of another alternate embodiment of the electric car 90. An electric car 90 comprises a car body 92 having a front end (not shown), a rear end 94, a top portion 96 and a bottom portion 98. In another alternate embodiment 90, the car body 92 is made in such way so as to achieve a different appearance. A center console (not shown) is placed at an interior forepart (not shown) of the electric car 90. A steering (not shown) is attached to the center console (not shown). A rectangular seat 100 is mounted on a rectangular box 102, the rectangular box 100 is longitudinally placed at a center part of the electric car 90. A back support 104 is utilized to provide sufficient support to the car driver. A storage area (not shown) is enclosed within the rectangular box 102, the storage area (not shown) includes a personal storage (not shown) and a battery storage (not shown). The battery storage (not shown) includes a battery pack (not shown) having a set of rechargeable batteries (not shown). The battery pack (not shown) is used to power the electric car 90. A plug point 106 is located at a rear end 94 of the electric car 90 for charging the battery pack (not shown). A pair of rotatable front wheels 108 and a pair of rotatable back wheels 110 are provided for ensuring smooth movement of the electric car 90.

In another embodiment of the present invention, at both corners of the rear-part of the electric car, a rear seat is placed at each corner interior to increase number of riders in the car.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. An electric car for accommodating at least one passenger, the electric car comprising:
a car body having a front end, a rear end, a top portion and a bottom portion;
a center console placed at an interior forepart of the electric car;
a steering attached to the center console;
a rectangular seat mounted on a rectangular box, the rectangular box being longitudinally placed at a center part of the electric car;
a storage area enclosed within the rectangular box, the storage area having a personal storage and a battery storage;
a plug point located at the rear end of the electric car for charging a battery pack; and
a pair of rotatable front wheels and a pair of rotatable back wheels for ensuring smooth movement of the electric car;
whereby the center console, the steering, the rectangular seat, the storage area, the plug point and the pair of rotatable front wheels and the pair of rotatable back wheels are integrated in the car body defining the electric car capable of accommodating more passengers with relatively small size and with minimum power consumption during transportation.

2. The electric car of claim 1 wherein the center console is aligned with the rectangular seat.

3. The electric car of claim 1 wherein the steering is aligned with the rectangular seat.

4. The electric car of claim 1 wherein the battery pack is used to power the electric car.

5. The electric car of claim 1 wherein the battery pack consists of a set of rechargeable batteries.

6. The electric car of claim 1 wherein a back support is provided for a driver's rectangular seat.

7. The electric car of claim 1 wherein the at least one passenger can be seated facing front direction with one leg on each side of the rectangular seat.

8. The electric car of claim 1 wherein minimum amount of power is consumed during the transportation.

9. The electric car of claim 1 wherein the rectangular seat is mounted on the rectangular box having the storage area so as to save space.

10. An electric car for accommodating at least one passenger, the electric car comprising:
a car body having a front end, a rear end, a top portion and a bottom portion;
a center console placed at an interior forepart of the electric car;
a steering attached to the center console;
a rectangular seat mounted on a rectangular box, the rectangular box being longitudinally placed at a center part of the electric car;
a rear seat placed at each left and right corner interior rear-part of the electric car;
a storage area enclosed within the rectangular box, the storage area having a personal storage and a battery storage;
a plug point located at the rear end of the electric car for charging a battery pack; and
a pair of rotatable front wheels and a pair of rotatable back wheels for ensuring smooth movement of the electric car;
whereby the center console, the steering, the rectangular seat, the storage area, the plug point and the pair of rotatable front wheels and the pair of rotatable back wheels are integrated in the car body defining the electric car capable of accommodating more passengers with relatively small size and with minimum power consumption during transportation.

12. The electric car of claim 1 wherein the center console is aligned with the rectangular seat.

13. The electric car of claim 1 wherein the steering is aligned with the rectangular seat.

14. The electric car of claim 1 wherein the battery pack is used to power the electric car.

15. The electric car of claim 1 wherein the battery pack consists of a set of rechargeable batteries.

16. The electric car of claim 1 wherein a back support is provided for a driver's rectangular seat.

17. The electric car of claim 1 wherein the at least one passenger can be seated facing front direction with one leg on each side of the rectangular seat.

18. The electric car of claim 1 wherein minimum amount of power is consumed during the transportation.

19. The electric car of claim 1 wherein the rectangular seat is mounted on the rectangular box having the storage area so as to save space.
